(19) United States
(12) Patent Application Publication
(10) Pub. No.: US 2026/0235482 A1
(43) Pub. Date: Aug. 13, 2026

(54) Method for characterizing the fracture surface of a material having undergone cracking

(71) Applicant: TORTOISE, Paris (FR)

(72) Inventors: Patrick RIBEIRO, Les Clayes-sous-Bois (FR); Laurent PONSON, Paris (FR)

(73) Assignee: TORTOISE, Paris (FR)

(21) Appl. No.: 19/160,035

(22) PCT Filed: Feb. 21, 2024
(86) PCT No.: PCT/EP2024/054364

§ 371 Date: Aug. 27, 2025

(30) Foreign Application Priority Data
Feb. 27, 2023 (FR) FR2301807

(51) Int. Cl. G01N 3/06

(52) U.S. Cl. CPC G01N 3/06; G01N 2203/0067; G01N 2203/0647

(57) ABSTRACT

The invention relates to a method for characterizing the fracture surface of a material having undergone cracking, comprising the steps of carrying out a topographic map of said fracture surface, and determining physical cracking characteristics (ξ_{λ}, L_{c}) from the field of the signs of the slopes of the cracking surface.

The present invention relates to the field of statistical fractography, i.e. material fracture surface analysis.

Many studies have focused on such analyses: indeed, it has emerged that the topographic map of the fracture surface of a material contains many items of information which, correctly processed and interpreted, make it possible to better understand the causes and modalities of a fracture.

This better understanding of fracture phenomena is essential in many fields, such as aeronautics, where it is sought to implement preventive measures to prevent the appearance of cracks, and particularly microcracks, which are the precursor to the material fracture phenomenon.

The aim of the present invention is particularly that of providing a novel approach allowing access to quantities representative on a microscopic scale of the phenomenon of the appearance of cracks in a material, and particularly useful for characterizing the conditions leading to material fracture.

This aim of the invention is achieved with a method for characterizing the fracture surface of a material having undergone cracking, comprising the steps of:
carrying out a topographic map of said fracture surface,
determining, for a set of points taken in the mid-plane of said fracture surface, heights of each of these points relative to this mid-plane,
choosing a set of resolution scales,
projecting on an axis, for these resolution scales, normalized fields of the differences in height between said points,
determining the spatial autocorrelation of the projected fields thus obtained,
determining the computing intervals making it possible, for each given angle, to maximize the standard deviation of the spatial autocorrelation of said fields on the set of resolution scales,
determining the propagation angle value of said crack as that, among the set of said angles, making it possible to obtain the highest value of said maximized values of said standard deviation, and
deducing from this propagation angle value at least one quantity representative of physical cracking characteristics.

According to other optional features of the method according to the invention:
a characteristic damage scale is determined, representative of the distance between the microcavities that are formed in the zone of said cracking, corresponding to the maximum of the standard deviation of the spatial autocorrelation of said fields measured on said resolution scales for said propagation angle;
a cohesive zone length, representative of the total length of the zone wherein microcavities appear just before material fracture, is determined from the rank numbers of relative maxima and minima of spatial autocorrelation of said fields measured on said resolution scales, for said propagation angle;
the toughness of said material is determined from the characteristic damage scale and cohesive zone length values.

Other features and advantages of the invention will become apparent upon reading the following description, with reference to the appended figures, which illustrate:

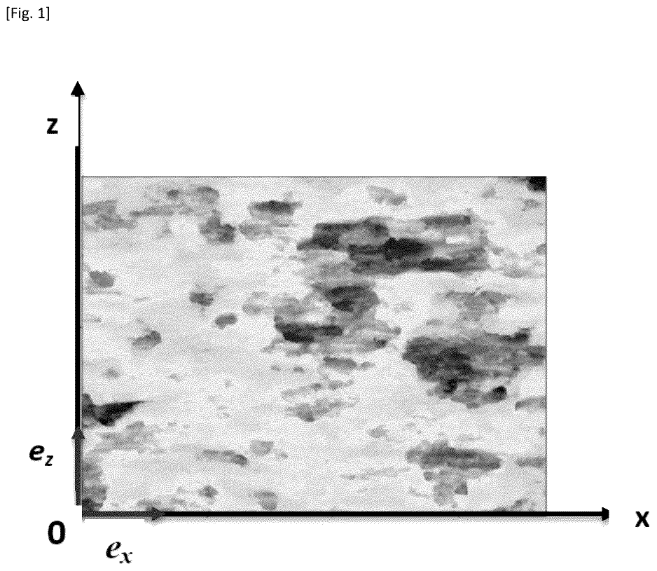

FIG. 1: a topographic map of a fracture surface of a material, positioned in a reference frame X, Z;

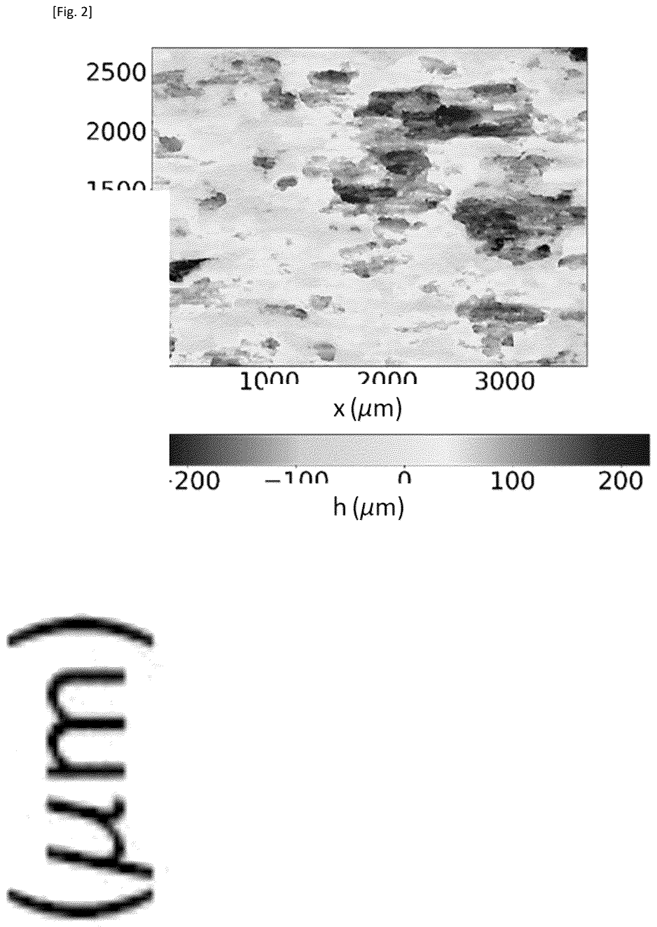

FIG. 2: mapping of a fracture surface of an aluminum sample, with a crack propagation direction parallel to the x-axis X, and indication of the differences in height relative to the mid-plane of this sample;

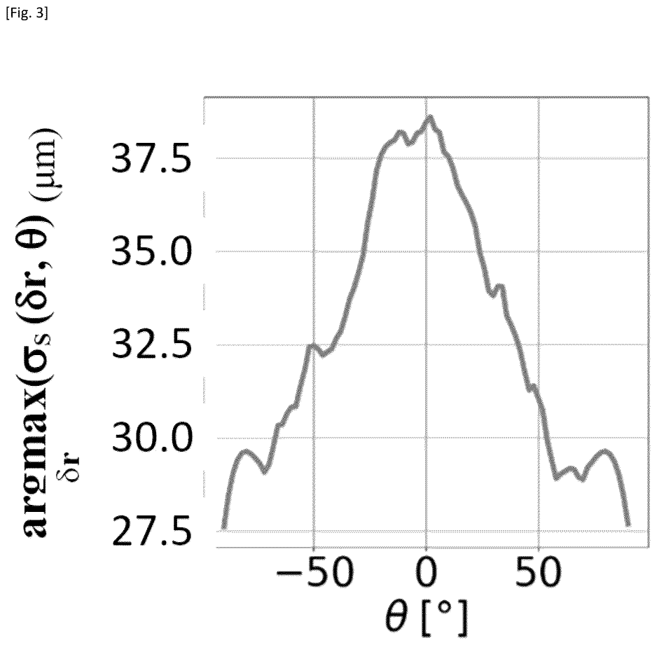

FIG. 3: a graph showing a maximum value for determining the crack propagation direction;

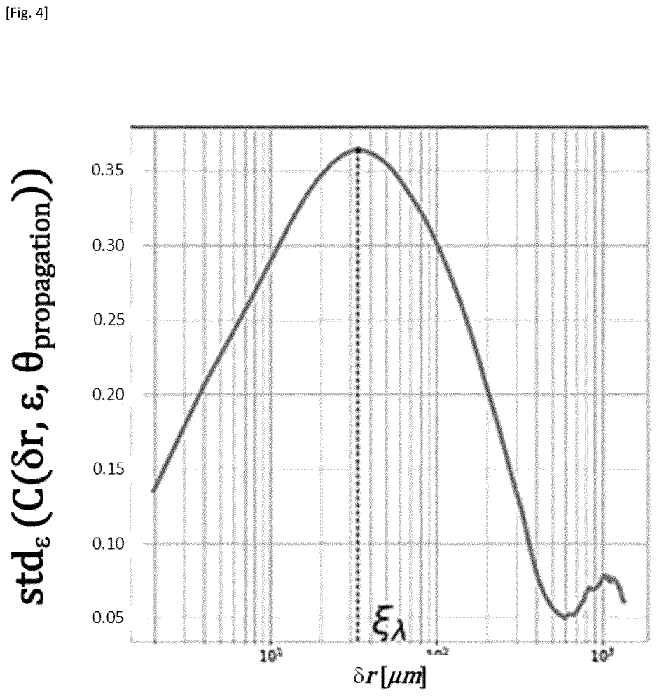

FIG. 4: a graph showing a maximum value for determining a representative value of the cracking phenomenon on a microscopic scale;

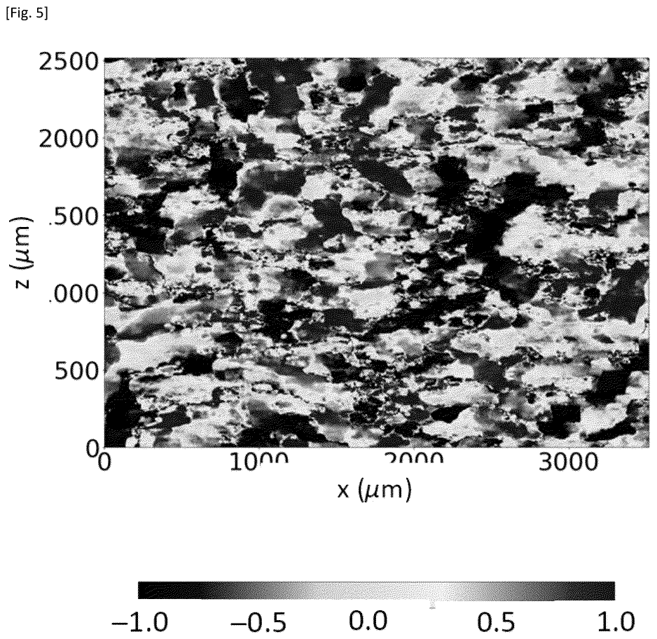

FIG. 5: a normalized field map of a fracture surface of an aluminum sample for a particular resolution scale;

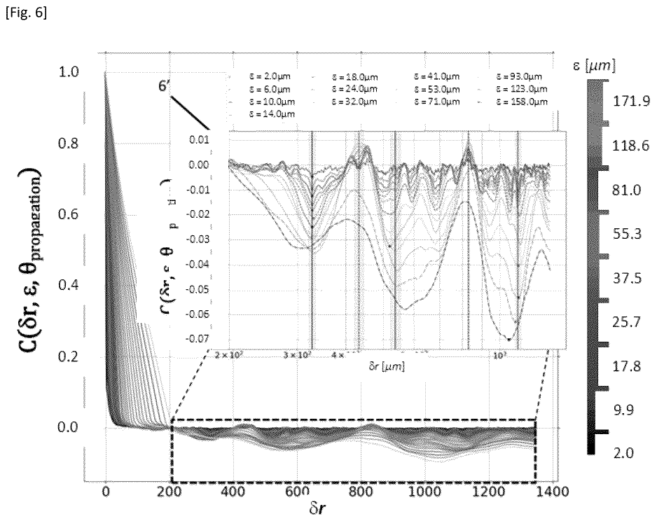

FIG. 6: a plurality of normalized field autocorrelation curves each corresponding to a scale in μm indicated in the legend located to the right of the figure, with a zoomed-in portion 6′; and

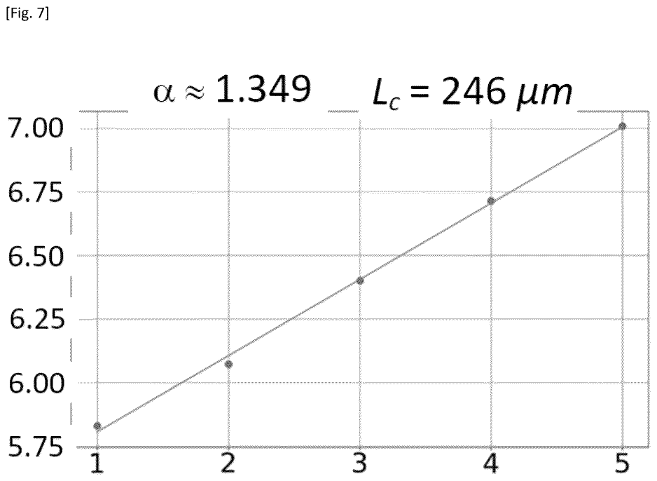

FIG. 7: a graph containing values deduced from the curves of FIG. 6, representing the power law structure of the successive minima and maxima according to their ranks.

For more clarity, identical or similar elements bear identical or similar reference numerals in all the figures.

It is assumed that it was possible to retrieve a sample of a material which has undergone fracture, i.e. which has broken into at least two pieces after the appearance of a crack.

Each of these pieces of material therefore has a fracture surface, which is subjected to a profilometry apparatus, making it possible to produce a topographical map of this fracture surface, i.e. determine the heights of each of the points of this fracture surface, relative to a mid-plane of this fracture surface.

In practice, this topographic map is carried out according to a setpoint interval, so that in reality a grid of points located on the fracture surface is obtained, the height of which is known by the profilometry apparatus relative to the mid-plane of the fracture surface.

As can be seen in FIG. 1, this point grid can be associated with a reference frame XZ, defining a plane coincident with the mid-plane of the fracture surface.

The method is started by defining a resolution scale ϵ and computing, for each mapped point of coordinates (x, z), the normalized field S(x, z, ϵ) determined as follows:

$$S ( x , z , ϵ ) = \frac{\vec{δ} h ( x , z , ϵ ) \cdot \vec{{e}_{x}}}{‖ \vec{δ} h ( x , z , ϵ ) ‖} ; \vec{δ} h ( x , z , ϵ ) = [ \begin{matrix}( \frac{h ( x + ϵ ) - h ( x )}{ϵ} ) \vec{{e}_{x}} \\ ( \frac{h ( z + ϵ ) - h ( z )}{ϵ} ) \vec{{e}_{z}}\end{matrix} ]$$

where \vec{δ}h(x, z, ϵ) is the height difference vector between the points of coordinates (x, z) and the points of coordinates (x+ϵ, z+ϵ).

The physical meaning of this normalized field is the projection on the axis X of the reference frame XZ of the normalized height gradient between the points of coordinates (x, z) and the points of coordinates (x+ϵ, z+ϵ).

This normalized field, the values of which are between −1 and 1, is thus representative of the direction and angle of the slope connecting each point of coordinates (x, z) to the point of coordinates (x+ϵ, z+ϵ).

The spatial autocorrelation of the field S along the direction X is then determined, defined as follows:

$$C ( δ x , ϵ ) = \frac{〈 S ( x , z , ϵ ) \cdot S ( x + δ x , z , ϵ ) 〉}{〈 {S ( x , z , ϵ )}^{2} 〉}$$

where [symbol] [symbol] means the mean computed on the set of points of coordinates (x, z) for the resolution scale ϵ, and δx the offset interval measured along the direction X to compute the spatial autocorrelation of the field S.

Hereinabove, the reference frame XZ has any orientation relative to the propagation direction of the crack leading to the material fracture.

However, it was observed that the standard deviation σ_{S}(δr, θ)=std_{ε}(C(δr, ε, θ)) of the spatial autocorrelation of the field S measured on the set of resolution scalesε, for a defined interval δr and direction θ, was maximum for a value of θ corresponding to the crack propagation direction, which can be written as follows:

$${θ}_{propagation} \approx {arg max}_{θ} ( {arg max}_{θ} ( {σ}_{S} ( δ r , θ ) )$$

In this way, the crack propagation direction θ_{propagation} can be determined.

This is illustrated in FIG. 2, wherein, in the plane XZ of the fracture surface of an aluminum sample, the mapping of the differences in height h of the fracture surface relative to the mid-plane of this surface (values between −200 and +200 (μm), as indicated on the scale located below the figure), can be seen.

In this FIG. 2, the propagation direction of the crack leading to the fracture of the material is oriented parallel to the axis X.

On the x-axis of FIG. 3, the angle θ has been represented, of which the value 0° corresponds to the crack propagation direction, and on the y-axis, the value

$${argmax}_{δ r} ( {σ}_{s} ( δ r , θ ) .$$

As can be seen in FIG. 3, this value

$${arg max}_{δ r} ( {σ}_{S} ( δ r , θ )$$

takes a maximum equal to about 38 μm for θ=0, ° i.e. in the crack propagation direction.

Alternatively, θ_{propagation} can be determined as being the value of θ which makes it possible to maximize the integral I(θ) on δr of the standard deviation σ_{S}(δr, θ)=std_{ε}(C(δr, ε, θ)) of the spatial autocorrelation of the field S measured on the set of resolution scales E, which can be written as follows:

$${θ}_{propagation} \approx {arg max}_{θ} ( I ( θ ) = {\int }_{δ r} {std}_{ε} ( C ( δ r , ε , θ ) ) δ r )$$

Once this crack propagation direction has been obtained, it is possible to determine the value of the interval δr which makes it possible to maximize the standard deviation of spatial autocorrelation of the field S measured on the set of resolution scales ε and in the crack propagation direction:

$${arg max}_{δ r} ( {std}_{ε} ( C ( δ r , ε , {θ}_{propagation} ) ) )$$

This maximization, obtained in the crack propagation direction for a particular interval value δr=ξ_{λ}, called “characteristic damage scale”, is shown as an example in the graph of FIG. 4 for an aluminum sample: on the x-axis of this graph, the interval values are shown δr, and on the y-axis of this graph, the values of the function std_{ε}(C(δr, ε, θ_{propagation})). are shown.

In this particular example, the characteristic damage scale ξ_{λ}, corresponding to the vertex of the curve, is approximately 33.6 μm.

It is observed that this maximizing value of the interval δr=ξ_{λ}, is representative of the distance between the microcavities formed in the cracking zone of the material studied.

It is moreover observed that C(δr, ε, θ_{propagation}), i.e. the spatial autocorrelation of the field S for the interval δr and the resolution scale ε, measured along the crack propagation direction θ_{propagation}, takes a succession of relative maxima and minima when the interval varies, and that these relative maxima and minima are to a large extent independent of the chosen scale ε.

This is illustrated by FIGS. 5 and 6 appended hereto.

In FIG. 5, in the plane XZ of the fracture surface of an aluminum sample, the mapping of the normalized field S (values between −1 and 1, as indicated on the scale located below the figure), representative of the directions and senses of the slopes of this surface, can be seen.

In FIG. 6, a plurality of curves each corresponding to a resolution scale ε in μm indicated in the legend located to the right of the figure.

These curves indicate, for each scale ε and along the crack propagation direction θ_{propagation}, the values C(δr, ε, θ_{propagation}), i.e. the spatial autocorrelation of the field S, according to the interval δr in μm.

As can be seen in this FIG. 6 (see in particular the zoomed-in part 6′), the peaks (relative minima) and troughs (relative minima) of these curves appear substantially for the same values of δr regardless of the resolution scale ε, i.e. in this case:

TABLE 1

| | Peaks/troughs | | | | |
|---|---|---|---|---|---|
| | 1^{st} trough | 1^{st} peak | 2^{nd} trough | 2^{nd} peak | 3^{rd} trough |
| Rank No. | 1 | 2 | 3 | 4 | 5 |
| δr in μm | 328 | 433 | 538 | 831 | 1116 |

In FIG. 7, a graph is shown, wherein the x-axis contains the rank numbers, and the y-axis contains the logarithms of the values of δr corresponding to these rank numbers.

As can be seen in this graph, an affine relationship is obtained between these two families of parameters, i.e. they are interlinked by an equation of the type:

$$ln ( δ {r}_{i} ) = α \times i + ln ( δ {r}_{0} )$$

where i is the peak or trough rank number, δrᵢ is the length of the interval corresponding to the trough or to the peak of rank i, α is the slope of the line shown in FIG. 7, and l n(δr₀) is the y-intercept of this line.

In the example shown, α equals about 1.349, and l n(δr₀) equals about 5.50, corresponding to a length δr₀ of 246 μm.

It is observed that this length δr₀ corresponds to a characteristic length of the cracking of the material studied.

This characteristic length, commonly called “cohesive zone length” and denoted L_{c}, is representative of the total length of the zone wherein the microcavities appear just before material fracture, i.e. just before these microcavities are joined by coalescence.

Therefore, as will be understood in the light of the above, the method according to the invention, which uses the field of the signs of the slopes of the fracture surface of a material, makes it possible to access, by computing, two key lengths for characterizing the crack at the origin of the fracture on a macroscopic scale:
ξ_{λ}, characteristic damage scale, representative of the distance between the microcavities formed in the cracking zone of the material studied,
   and
L_{c}, cohesive zone length, representative of the total length of the zone wherein the microcavities appear just before material fracture.

These characteristic lengths can then be used for many applications, such as for example determining the fatigue strength of a fractured material, or determining the toughness of this material, i.e. determining the stress intensity leading to its fracture.

The toughness K_{c} of metal alloys can be obtained using the following formula:

$${K}_{c} ( {ξ}_{λ} , {L}_{c} ) = {A}_{0} \sqrt{{σ}_{y} {Eξ}_{λ}}$$

$${K}_{c} ( {ξ}_{λ} , {L}_{c} ) = {B}_{0} \sqrt{{σ}_{y} {EL}_{c}}$$

where E is the Young's modulus of the material, σ_{y} its yield strength and the dimensionless constants A₀ and B₀ are dependent on the tensile behavior law of the material. The toughness K_{c} of brittle materials (ceramics, rocks, etc.) can be obtained using the following formula:

$${K}_{c} ( {ξ}_{λ} , {L}_{c} ) = {C}_{0} E \sqrt{{ξ}_{λ}}$$

$${K}_{c} ( {ξ}_{λ} , {L}_{c} ) = {D}_{0} E \sqrt{{L}_{c}}$$

where E is the Young's modulus of the material and the dimensionless constants C₀ and D₀ are dependent on the tensile behavior law of the material.

Of course, the invention is described above by way of example. It is understood that a person skilled in the art is capable of creating various alternative embodiments of the invention without departing from the scope of the invention.

1. A method for characterizing the fracture surface of a material having undergone cracking, comprising the steps of:
carrying out a topographic map of said fracture surface,
determining, for a set of points taken in the mid-plane of said fracture surface, heights of each of these points relative to this mid-plane,
choosing a set of resolution scales(ε),
projecting on an axis (X), for these resolution scales, normalized fields (S) of the differences in height (h) between said points,
determining the spatial autocorrelation
$$( C ( δ x , ϵ ) = \frac{〈 S ( x , z , ϵ ) \cdot S ( x + δ x , z , ϵ ) 〉}{〈 {S ( x , z , ϵ )}^{2} 〉} )$$
of the projected fields thus obtained,
determining the computing intervals (δr) making it possible, for each given angle (θ), to maximize
$$( {arg max}_{δ r} ( {std}_{ε} ( C ( δ r , ε , θ ) ) )$$
the standard deviation of the spatial autocorrelation of said fields on the set of resolution scales,
determining the propagation angle value (θ_{propagation}) of said crack as that,
$$( {θ}_{propagation} \approx {arg max}_{θ} ( {arg max}_{δ r} ( {σ}_{S} ( δ r , θ ) ) )$$
among the set of said angles (θ), making it possible to obtain the highest value of said maximized values of said standard deviation, and
deducing from this propagation angle value θ_{propagation} at least one quantity (ξ_{λ}, L_{c}) representative of physical cracking characteristics.

2. The method according to claim 1, wherein a characteristic damage scale (ξ_{λ}) is determined, representative of the distance between the microcavities that are formed in the zone of said cracking, corresponding to the maximum of the standard deviation std_{ε} (C(δr, ε, θ_{propagation})) of the spatial autocorrelation of said fields (S) measured on said resolution scales (ϵ) for said propagation angle (θ_{propagation}).

3. The method according to claim 1, wherein a cohesive zone length (L_{c}), representative of the total length of the zone wherein microcavities appear just before material fracture, is determined from the rank number of relative maxima and minima of spatial autocorrelation of said fields (S) measured on said resolution scales, for said propagation angle (θ_{propagation}).

4. The method according to claim 1, wherein the toughness of said material (K_{c}(ξ_{λ}, L_{c})) is determined from a characteristic damage scale (ξ_{λ}) and a cohesive zone length (L_{c}) values,
wherein a characteristic damage scale (ξ_{λ}) is determined, representative of the distance between the microcavities that are formed in the zone of said cracking, corresponding to the maximum of the standard deviation std_{ε} (C(δr, ε, θ_{propagation})) of the spatial autocorrelation of said fields (S) measured on said resolution scales (ϵ) for said propagation angle (θ_{propagation}), and
wherein a cohesive zone length (L_{c}), representative of the total length of the zone wherein microcavities appear just before material fracture, is determined from the rank number of relative maxima and minima of spatial autocorrelation of said fields (S) measured on said resolution scales, for said propagation angle (θ_{propagation}).

5. The method according to claim 2, wherein a cohesive zone length (L_{c}), representative of the total length of the zone wherein microcavities appear just before material fracture, is determined from the rank number of relative maxima and minima of spatial autocorrelation of said fields (S) measured on said resolution scales, for said propagation angle (θ_{propagation}).
